(19) United States
(12) Patent Application Publication
(10) Pub. No.: US 2014/0006916 A1
(43) Pub. Date: Jan. 2, 2014

(54) PRE-READING METHOD AND APPARATUS

(71) Applicant: TENCENT TECHNOLOGY (SHENZHEN) COMPANY LIMITED, Shenzhen City (CN)

(72) Inventor: Hao Xu, Shenzhen City (CN)

(73) Assignee: TENCENT TECHNOLOGY (SHENZHEN) COMPANY LIMITED, Shenzhen City (CN)

(21) Appl. No.: 14/018,817

(22) Filed: Sep. 5, 2013

Related U.S. Application Data
(63) Continuation of application No. PCT/CN2012/070890, filed on Feb. 6, 2012.

(30) Foreign Application Priority Data
Mar. 7, 2011 (CN) CN201110053997.3

(51) Int. Cl. G06F 17/22

(52) U.S. Cl. CPC G06F 17/2235
USPC 715/205

(57) ABSTRACT

The present invention, pertaining to the field of mobile terminals, discloses a pre-reading method and apparatus. The method includes: acquiring a pre-reading link according to the current web page and pre-reading rules when opening a web page; and reading content of a web page indicated by the pre-reading link. The apparatus includes: an acquiring module and a reading module. A client acquires pre-reading rules from a server, and pre-reads a web page according to the pre-reading rules and the link of the current web page. This prevents low pre-reading efficiency due to use of a keyword determined by hard coding, implements adaptive updating of the pre-reading manner according to the current web page. In this way, not only user traffic is saved, but also the speed and efficiency of browsing web pages are improved.

### FIELD OF THE INVENTION

The present invention relates to the field of mobile terminals, and in particular, to a pre-reading method and apparatus.

### BACKGROUND OF THE INVENTION

With constraints such as limited mobile network bandwidth and unstable network connection, a mobile phone client, especially a mobile phone browser, typically uses a pre-reading function to shorten the actual waiting time for opening a web page. The pre-reading refers to that when a user browses web page A, all links on web page A are traversed, a link which he or she most probably accesses is judged, the web page content directed by the link is pre-read, and the web page is immediately displayed to the user when the user actually clicks the link.

Pre-reading on the mobile phone browser is simply implemented by using “next page” and “the following page” that are fixed by coding as pre-reading keywords, to improve user experience when browsing specific websites such as news and novels.

After analysis on the prior art, the inventor finds that the prior art has at least the following disadvantages:

In the pre-reading method according to the prior art, a keyword is typically fixed by hard coding, failing to be properly updated. Moreover, it is difficult to implement pre-reading by using the most suitable keyword selected according to characteristics of different websites. As a result, the efficiency in pre-reading web pages except specific news and novel websites is low, and user traffic is wasted.

### SUMMARY OF THE INVENTION

To save user traffic of a mobile terminal and improve the speed and efficiency of browsing web pages, embodiments of the present invention provide a pre-reading method and apparatus. The technical solutions are as follows:

A pre-reading method includes:

acquiring a pre-reading link according to a current web page and pre-reading rules when opening a web page; and

reading content of a web page indicated by the pre-reading link.

Prior to the acquiring a pre-reading link according to a current web page and pre-reading rules when opening a web page, the method includes:

acquiring, by a client, the pre-reading rules from a server.

The acquiring, by a client, the pre-reading rules from a server includes:

requesting, by the client, the pre-reading rules from the server, judging whether pre-reading rules stored in the server are the same as those stored in the client, and if different, updating the pre-reading rules stored in the client by using the pre-reading rules stored in the server.

After the acquiring, by a client, the pre-reading rules from a server, the method further includes:

identifying the type of the current web page, and acquiring pre-reading rules corresponding to the type of the current web page from the server.

The identifying the type of the current web page specifically includes:

acquiring the type of the current web page by querying according to a domain name or a link of the current web page and pre-stored website information category.

The acquiring a pre-reading link according to a current web page and pre-reading rules when opening a web page specifically includes:

judging whether the current web page matches the web address rules in the pre-reading rules, and if true, acquiring a link corresponding to the web address rules in the pre-reading rules from the current web page, and using the link as the pre-reading link.

The judging whether the current web page matches the web address rules in the pre-reading rules specifically includes:

Judging whether the web address of the current web page includes a web address field satisfying the web address rules; where if true, the current web page matches the web address rules in the pre-reading rules; and otherwise, the current web page does not match the web address rules in the pre-reading rules.

The acquiring a link corresponding to the web address rules in the pre-reading rules from the current web page, and using the link as the pre-reading link specifically include:

traversing the current web page, judging whether the current web page includes a keyword depicted in the web address rules in the pre-reading rules, and if true, using the link corresponding to the keyword as the pre-reading link.

The method further includes:

recording, by the client, browsing details after the pre-reading rules are applied, comparing the browsing details with the pre-reading rules, and reporting a success rate of the pre-reading rules to the server.

A pre-reading apparatus includes:

an acquiring module, configured to acquire a pre-reading link according to a current web page and pre-reading rules when opening a web page; and

a reading module, configured to read content of a web page indicated by the pre-reading link.

The apparatus further includes:

a rule acquiring module, configured to acquire the pre-reading rules from a server.

The rule acquiring module includes:

a requesting unit, configured to request the pre-reading rules from the server, judge whether pre-reading rules stored in the server are the same as those stored in the client, and if different, update the pre-reading rules stored in the client by using the pre-reading rules stored in the server.

The rule acquiring module is further configured to, after the server acquires the pre-reading rules, identify the type of the current web page, and acquire pre-reading rules corresponding to the type of the current web page from the server.

The rule acquiring module includes an identifying unit, configured to acquire the type of the current web page by querying according to a domain name or a link of the current web page and pre-stored website information category.

The acquiring module includes:

a judging unit, configured to judge whether the pre-reading rules include web address rules matching with the current web page, and if true, trigger an acquiring unit to acquire a link corresponding to the matched web address rules from the current web page and use the link as the pre-reading link.

The judging unit is specifically configured to judge whether the pre-reading rules include a web address field of the current web page; where if true, the pre-reading rules include the web address rules matching with the current web page, and otherwise, the pre-reading rules do not include the web address rules matching with the current web page.

The judging unit includes:

a judging subunit, configured to judge whether the current web page includes a keyword depicted in the matched web address rules, and if true, use the link corresponding to the keyword as the pre-reading link.

The apparatus further includes:

a reporting module, configured to record browsing details after the pre-reading rules are applied, compare the browsing details with the pre-reading rules, and report a success rate of the pre-reading rules to the server.

A mobile terminal includes any of the above-described pre-reading apparatuses.

The technical solutions according to the embodiments of the present invention achieve the following beneficial effects:

A client acquires pre-reading rules from a server, and pre-reads a web page according to the pre-reading rules and the link of the current web page. This prevents low pre-reading efficiency due to use of a keyword determined by hard coding, implements adaptive updating of the pre-reading manner according to the current web page. In this way, not only user traffic is saved, but also the speed and efficiency of browsing web pages are improved.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and persons of ordinary skill in the art can derive other drawings from these accompanying drawings without creative efforts.

FIG. 1 is a flowchart of a pre-reading method according to an embodiment of the present invention;

FIG. 2 is a flowchart of a pre-reading method according to an embodiment of the present invention;

FIG. 3 is a schematic structural diagram of a pre-reading apparatus according to an embodiment of the present invention;

FIG. 4 is a schematic structural diagram of a pre-reading apparatus according to an embodiment of the present invention;

FIG. 5 is a schematic structural diagram of a pre-reading apparatus according to an embodiment of the present invention;

FIG. 6 is a schematic structural diagram of a pre-reading apparatus according to an embodiment of the present invention; and

FIG. 7 is a schematic structural diagram of a pre-reading apparatus according to an embodiment of the present invention.

### DETAILED DESCRIPTION OF THE INVENTION

To make the objectives, technical solutions, and advantages of the present invention clearer, the embodiments of the present invention are described in detail below with reference to the accompanying drawings.

C/S refers to client/server.

A client refers to the mobile phone browser running on a mobile phone, or may be another client such as a mobile phone reader. In addition, all programs implementing specific functions and running on the mobile terminal (for example, a mobile phone) may be used as the client applied in the present invention.

### Embodiment 1

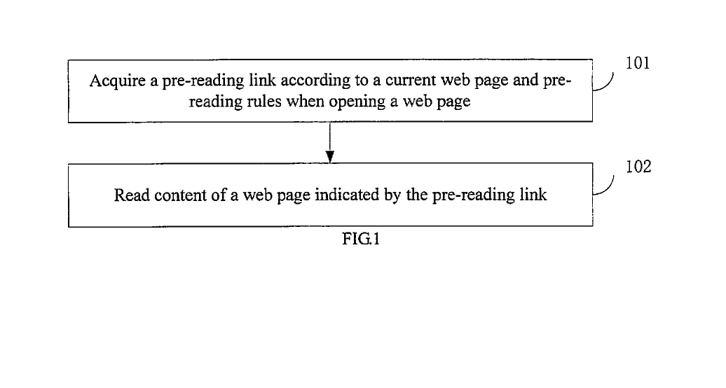

To improve the flexibility of pre-reading, and save user traffic, an embodiment of the present invention provides a pre-reading method. In this embodiment, the pre-reading method is performed by a client, where the client may be a browser running on a mobile device, or may be another client such as a mobile phone reader. In addition, all programs implementing specific functions and running on the mobile terminal (for example, a mobile phone) may be used as the client applied in the present invention. Referring to FIG. 1, the method includes the following steps:

101: acquiring a pre-reading link according to a current web page and pre-reading rules when opening a web page; and

102: reading content of a web page indicated by the pre-reading link.

Furthermore, prior to the acquiring a pre-reading link according to a current web page and pre-reading rules when opening a web page, the method includes:

acquiring, by a client, the pre-reading rules from a server.

The acquiring, by a client, the pre-reading rules from a server includes:

requesting, by the client, the pre-reading rules from the server, judging whether pre-reading rules stored in the server are the same as those stored in the client, and if different, updating the pre-reading rules stored in the client by using the pre-reading rules stored in the server.

Furthermore, after the acquiring, by a client, the pre-reading rules from a server, the method further includes:

identifying the type of the current web page, and acquiring pre-reading rules corresponding to the type of the current web page from the server.

The identifying the type of the current web page specifically includes:

acquiring the type of the current web page by querying according to a domain name or a link of the current web page and pre-stored website information category.

The acquiring a pre-reading link according to a current web page and pre-reading rules when opening a web page specifically includes:

judging whether the pre-reading rules include web address rules matching with the current web page, and if true, acquiring a link corresponding to the matched web address rules from the current web page, and using the link as the pre-reading link.

The judging whether the pre-reading rules include web address rules matching with the current web page specifically includes:

judging whether the pre-reading rules include a web address field of the current web page; where if true, the pre-reading rules include the web address rules matching with the current web page, and otherwise, the pre-reading rules do not include the web address rules matching with the current web page.

The acquiring a link corresponding to the matched web address rules from the current web page, and using the link as the pre-reading link specifically include:

judging whether the current web page includes a keyword depicted in the matched web address rules, and if true, using the link corresponding to the keyword as the pre-reading link.

The method further includes:

recording, by the client, browsing details after the pre-reading rules are applied, comparing the browsing details with the pre-reading rules, and reporting a success rate of the pre-reading rules to the server.

The success rate of the pre-reading rules may be a digital number, or a percentage. For example, with respect pre-reading rules A, during 10 times of pre-reading, if a user terminal pre-reads a web page for eight times, then the success rate of pre-reading rules is 80% or 0.8. A person skilled in the art may know that the success rate may also be in the form of a list which is composed of multiple success rates of the pre-reading rules. The success rate is reported at specific intervals during application of the pre-reading rules.

According to the method provided in this embodiment, a client acquires pre-reading rules from a server, and pre-reads a web page according to the pre-reading rules and the link of the current web page. This prevents low pre-reading efficiency due to use of a keyword determined by hard coding, implements adaptive updating of the pre-reading manner according to the current web page. In this way, not only user traffic is saved, but also the speed and efficiency of browsing web pages are improved.

### Embodiment 2

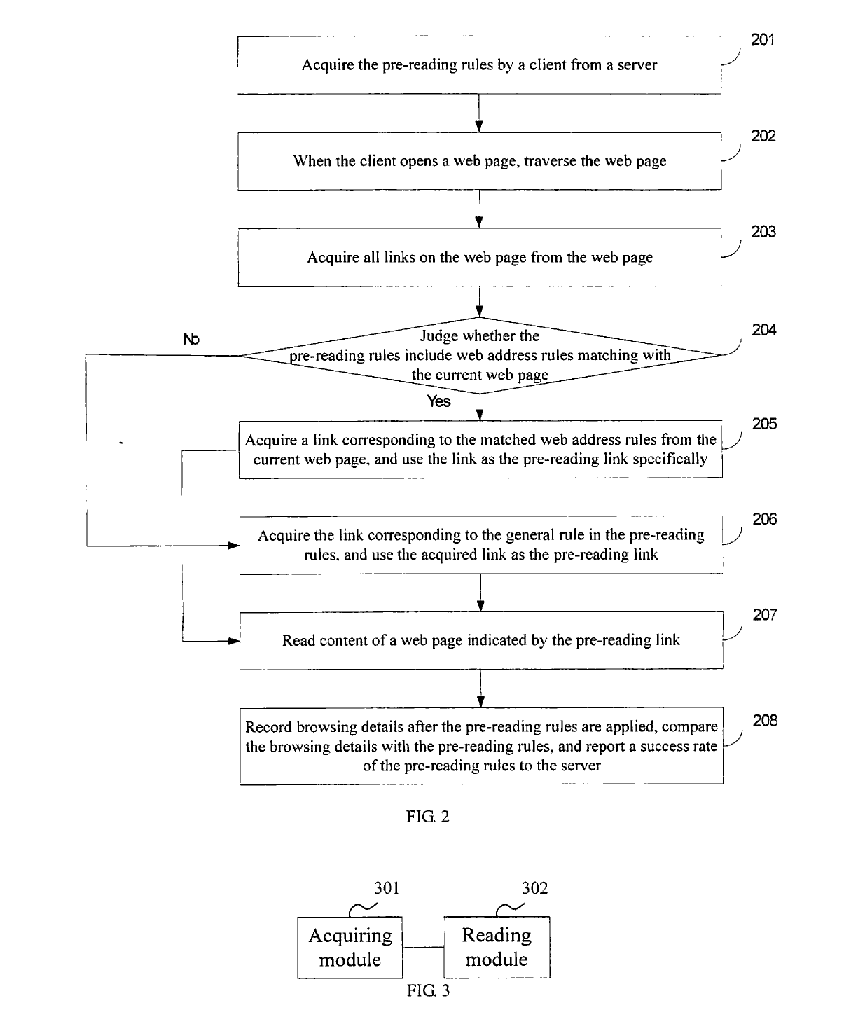

To improve the flexibility of pre-reading, and save user traffic, an embodiment of the present invention provides a pre-reading method. The two interactive parties in the pre-reading method according to this embodiment are a client and a server. The client may be a browser running on a mobile device, or may be another client such as a mobile phone reader. In addition, all programs implementing specific functions and running on the mobile terminal (for example, a mobile phone) may be used as the client applied in the present invention. The server may be a third party server. Referring to FIG. 2, the method includes the following steps

201: Acquiring the pre-reading rules by a client from a server.

In this embodiment, the acquisition may be performed during or after initiating of the client; the pre-reading rules are acquired from the server at specific intervals. After the client acquires and stores the pre-reading rules, when the browser of the client is initiated again, the pre-reading rules are applied for pre-reading.

The pre-reading rules, also referred to as rules, serve as a basis for the client to select pre-reading links, and are set in the server by a person skilled in the art.

It should be noted that, when the client acquires the pre-reading rules from the server, the acquisition step specifically includes: judging whether pre-reading rules stored in the server are the same as those stored in the client, and if different, updating the pre-reading rules stored in the client by using the pre-reading rules stored in the server. A person skilled in the art may know that the update refers to downloading pre-reading rules stored in the server and deleting pre-reading rules stored in the client.

202: When the client opens a web page, traversing the web page.

A person skilled in the art may known that when the a web page is browsed on the client, such content as pictures and HyperText Markup Language (HTML) pages on the web page is downloaded to the client, and the web page is displayed on the client.

203: Acquiring all links on the web page from the web page.

A person skilled in the art may know that the links refer to such elements as <a> and <anchor> in HTML or Wireless Markup Language (WML).

It should be noted that steps 202-203 may be performed simultaneously as the client opens a web page. These steps have no sequential relationship with step 204 that follows. To be specific, matching may be performed first, and then all links on the web page may be acquired; alternatively, all links may be performed first, and then matching may be performed.

204: Judging whether the pre-reading rules include web address rules matching with the current web page; if true, performing step 205; otherwise, performing step 206.

In step 204, the method for matching judgment specifically includes: judging whether the pre-reading rules include a web address field of the current web page; where if true, the pre-reading rules include the web address rules matching with the current web page, and otherwise, the pre-reading rules do not include the web address rules matching with the current web page.

A person skilled in the art may notice that the web address field of the current web page refers to a domain field or a flag field in the web address of the current web page, a pre-reading link suitable for the web page is selected by matching with the web address field with the pre-reading rules.

In this embodiment, the pre-reading rules include a plurality of web address rules for pre-reading the web page. Preferably, the pre-reading rules may be defined using the XML syntax. The pre-reading rules may be set on the server by a person skilled in the art according to the service nature and content of the website and reading preferences of common users.

For example, if the URL of the current link is http://www.qq.com/sports/index.jsp, and the pre-reading rules include rules corresponding to web address field http://www.qq.com/sports/, then the link of the web page matches with the web address rules in the pre-reading rules. The pre-reading keyword corresponding to the rules may be “live streaming”, and then the link corresponding to “live streaming” is selected as the pre-reading link.

In addition, the web address rules in the pre-reading rules may also be set for some specific websites. That is, the web address rule may be a website address rule, the web address rules may be applied on all web pages at a specific website, and the pre-reading rules may include no web address rule or a plurality of web address rules. In this case, the method for matching judgment in step 204 specifically includes: judging whether the web address of the current web page includes a website included in the web address rules; where if true, the pre-reading rules include the web address rules matching with the current web page; otherwise, the pre-reading rules do not include the web address rules matching with the current web page. For example, if the URL of a link is http://www.qq.com/sports/index.jsp, and the website address rule is qq.com, then the pre-reading rules include the web address rules matching with the current web page.

A person skilled in the art may know that during matching of the web address rules, since the pre-reading rules may include a plurality of web address rules, a comparison needs to be made between the currently accessed website and each of the web address rules in the pre-reading rules to judge whether the pre-reading rules include the web address rules matching with the website.

In another embodiment of the present invention, step 204 may also be: identifying the type of the currently browsed web page (i.e., the type of the current web page); acquiring the pre-reading rules corresponding to the type of the currently browsed web page from the pre-reading rules (i.e., from the pre-reading rules acquired by the server), and performing step 205. In this embodiment, the web pages may be categorized based on content thereon as follows: novel web pages, news web pages, and the like. The content on the web pages are diversified, which is not limited in the embodiments of the present invention. Alternatively, the web pages may be categorized based on the websites to which the web pages belong as follows: microblog web sites, shopping websites, comprehensive websites, and the like. The websites may be in a plurality of categories, which are not limited in the embodiments of the present invention. The method for identifying the type of the web page includes: acquiring the type of the browsed web page by query according to the current domain name or link and the pre-stored web site information category. For example, if the domain name of the currently browsed web page is t.qq.com, it is acquired by querying the pre-stored web page information category that t.qq.com is a microblog website. The website information category is set by a developer during development of the website, which includes an association between the domain name or link of the website and the website category. In addition, the website information category may also be determined according to a keyword in the link. For example, in website shop1234.taobao.com, the keyword corresponding to the website is taobao, and in this case, it is judged that the website is a shopping website.

205: Acquiring a link corresponding to the matched web address rules from the current web page, using the link as the pre-reading link, and then performing step 207.

Step 205 specifically includes:

judging whether the current web page includes a keyword depicted in the matched web address rules, and if true, using the link corresponding to the keyword as the pre-reading link.

It should be noted that the web address rules include a keyword sequence. A person skilled in the art may know that, in step 205, when the web address rules in the pre-reading rules match with the web address of the current web page, the client uses the keyword sequence (a plurality of keywords may be used) of the matched rules to query the content of the current web page, and acquires the link corresponding to any of the keywords in the keyword sequence.

In this embodiment, firstly a keyword sequence to be used is determined according to the rules matching with the current web page, and then matching is performed for the anchor texts corresponding to all links on the current web page according to the keyword sequence. The first matched link is the pre-reading link.

206: Acquiring the link corresponding to the general rule in the pre-reading rules, using the acquired link as the pre-reading link, and then performing step 207.

Further, when the web page does not match with the pre-reading rules, a preset general rule is used. Preferably, the general rule may be: acquiring the link corresponding to a keyword from the content of the web page, where the keyword includes “next page”, “the following page”, “next chapter”, and “the following chapter”.

For example, the general rule is defined using the XML syntax as follows:

```
    <GeneralRule>
<KeyWord>Next Page</KeyWord>
<KeyWord>Next page</KeyWord>
<KeyWord>Next Chapter</KeyWord>
<KeyWord>Next Chapter</KeyWord>
    </GeneralRule>
```

It should be noted that the website address rules may be applied on all web pages at a specific website, and the pre-reading rules may include no website address rule or a plurality of website address rules; the web address rules may be applied on a specific web page, and the pre-reading rules may include no web address rule or a plurality of web address rules; and the general rule may be applied when no other rules are matched for the current web page, where when the general rule is applied, the pre-reading rules include but only one general rule.

A complete rule is exemplified as follows:

```
<PreReadRules>
    <GeneralRule>
<KeyWord>Next page</KeyWord>
<KeyWord>Next page</KeyWord>
<KeyWord>Next Chapter</KeyWord>
<KeyWord>Next Chapter</KeyWord>
    </GeneralRule>
    <SiteRule>
<Domain>www.newsmth.net</Domain>
<KeyWord>Previous Page</KeyWord>
    </SiteRule>
    <UrlRule>
<Url>http://3g.qq.com/index.jsp</Url>
<KeyWord>Next Page</KeyWord>
    </UrlRule>
</PreReadRules>
```

207: Reading content of a web page indicated by the pre-reading link.

A person skilled in the art may know that, to improve the pre-reading efficiency, the client may cache the web page to be read, and provide the cached web page to a user when the user clicks the link of the web page.

208: Recording by the client browsing details after the pre-reading rules are applied, comparing the browsing details with the pre-reading rules, and reporting a success rate of the pre-reading rules to the server.

In this embodiment, when a matched rule is used for pre-reading, the client compares the browsing details with the pre-reading rule; if a user clicks the pre-read web page, it is a valid pre-reading; otherwise, it is an invalid pre-reading. The client records the rule used in each web page pre-reading, and whether the pre-reading is valid. The records may be reported by the client periodically (for example, once a month) or may be initiatively acquired by the server. The server collects information from the client, and uses the collected information as a basis for validity judgment on the existing rules; and then may optimize and issue new rules. For example, assume that a success rate threshold of the pre-reading rules set in the server is 0.7, if the success rate of the pre-reading rules reported by the client is 0.8, then the pre-reading rules have a high accuracy and a high reuse rate; and if the success rate of the pre-reading rules reported by the client is 0.3, then the pre-reading rules have a low accuracy and a low reuse rate, and need to be adjusted. A person skilled in the art may know that the adjustment is a process of amending or modifying the keyword or web address rules in the pre-reading rules according to a result of analyzing whether the client, with the pre-reading rules applied, actually opens the pre-reading web page. The adjusted rules may be sent to the client when the client requests the pre-reading rules from the server again, such that the client updates the original pre-reading rules according to the adjusted rules.

According to the method provided in this embodiment, a client acquires pre-reading rules from a server, and pre-reads a web page according to the pre-reading rules and the link of the current web page. This prevents low pre-reading efficiency due to use of a keyword determined by hard coding, implements adaptive updating of the pre-reading manner according to the current web page. In this way, not only user traffic is saved, but also the speed and efficiency of browsing web pages are improved.

To improve the flexibility of pre-reading, and save user traffic, an embodiment of the present invention provides a pre-reading apparatus. Referring to FIG. 3, the apparatus includes:

an acquiring module 301, configured to acquire a pre-reading link according to a current web page and pre-reading rules when opening a web page; and

a reading module 302, configured to read content of a web page indicated by the pre-reading link.

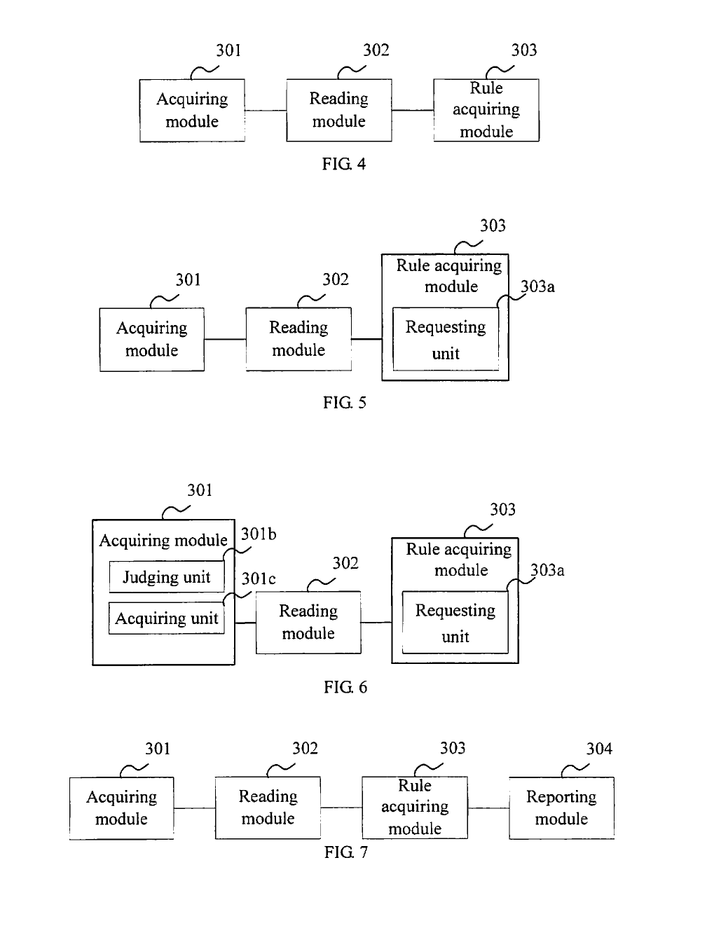

Referring to FIG. 4, the apparatus includes:

a rule acquiring module 303, configured to acquire the pre-reading rules from a server.

Referring to FIG. 5, the rule acquiring module 303 includes:

a requesting unit 303a, configured to request the pre-reading rules from the server, judge whether pre-reading rules stored in the server are the same as those stored in the client, and if different, update the pre-reading rules stored in the client by using the pre-reading rules stored in the server.

The rule acquiring module 303 is further configured to, after the server acquires the pre-reading rules, identify the type of the current web page, and acquire pre-reading rules corresponding to the type of the current web page from the pre-reading rules acquired by the server.

The rule acquiring module 303 includes an identifying unit, configured to acquire the type of the current web page by querying according to a domain name or a link of the current web page and pre-stored website information category.

Referring to FIG. 6, the acquiring module 301 includes:

a judging unit 301b, configured to judge whether the pre-reading rules include web address rules matching with the current web page, and if true, trigger an acquiring unit 301c to acquire a link corresponding to the matched web address rules from the current web page and use the link as the pre-reading link.

The judging unit 301b is specifically configured to judge whether the pre-reading rules include a web address field of the current web page; where if true, the pre-reading rules include the web address rules matching with the current web page, and otherwise, the pre-reading rules do not include the web address rules matching with the current web page.

The judging unit 301b includes:

a judging subunit, configured to judge whether the current web page includes a keyword depicted in the matched web address rules, and if true, use the link corresponding to the keyword as the pre-reading link.

Referring to FIG. 7, the apparatus further includes:

a reporting module 304, configured to record browsing details after the pre-reading rules are applied, compare the browsing details with the pre-reading rules, and report a success rate of the pre-reading rules to the server.

An embodiment of the present invention provides a mobile terminal, where the mobile terminal includes a pre-reading apparatus according to any of the above-described embodiments.

Preferably, the mobile terminal may be a network reading-enabled mobile terminal, such as iPads and mobile phones.

All or part of the technical solutions according to the embodiments of the present invention may be implemented by a program instructing relevant hardware. The program may be stored in a readable storage medium. The storage medium includes various mediums capable of storing program code, such as a read only memory (ROM), a random access memory (RAM), a magnetic disk, or a compact disc read-only memory (CD-ROM).

Described above are merely preferred embodiments of the present invention, but are not intended to limit the present invention. Any modification, equivalent replacement, or improvement made without departing from the spirit and principle of the present invention should fall within the protection scope of the present invention.

1. A pre-reading method, comprising:
acquiring a pre-reading link according to the current web page and pre-reading rules when opening a web page; and
reading content of a web page indicated by the pre-reading link.

2. The method according to claim 1, wherein prior to the acquiring a pre-reading link according to the current web page and pre-reading rules, the method comprises:
acquiring, by a client, the pre-reading rules from a server.

3. The method according to claim 2, wherein the acquiring, by a client, the pre-reading rules from a server comprises:
requesting, by the client, the pre-reading rules from the server, judging whether pre-reading rules stored in the server are the same as those stored in the client, and if different, updating the pre-reading rules stored in the client by using the pre-reading rules stored in the server.

4. The method according to claim 2, wherein after the acquiring, by a client, the pre-reading rules from a server, the method further comprises:
identifying the type of the current web page, and acquiring pre-reading rules corresponding to the type of the current web page from the server.

5. The method according to claim 4, wherein the identifying the type of the current web page specifically comprises:
acquiring the type of the current web page by querying according to a domain name or a link of the current web page and pre-stored website information category.

6. The method according to claim 1, wherein the acquiring a pre-reading link according to a current web page and pre-reading rules specifically comprises:
judging whether the pre-reading rules comprise web address rules matching with the current web page, and if true, acquiring a link corresponding to the matched web address rules from the current web page, and using the link as the pre-reading link.

7. The method according to claim 6, wherein the judging whether the pre-reading rules comprise web address rules matching with the current web page specifically comprises:
judging whether the pre-reading rules comprise a web address field of the current web page; wherein if true, the pre-reading rules comprise the web address rules matching with the current web page, and otherwise, the pre-reading rules do not comprise the web address rules matching with the current web page.

8. The method according to claim 6, wherein the acquiring a link corresponding to the matched web address rules from the current web page, and using the link as the pre-reading link specifically comprise:
judging whether the current web page comprises a keyword depicted in the matched web address rules, and if true, using the link corresponding to the keyword as the pre-reading link.

9. The method according to claim 1, further comprising:
recording, by the client, browsing details after the pre-reading rules are applied, comparing the browsing details with the pre-reading rules, and reporting a success rate of the pre-reading rules to the server.

10. A pre-reading apparatus, comprising:
an acquiring module, configured to acquire a pre-reading link according to a current web page and pre-reading rules when opening a web page; and
a reading module, configured to read content of a web page indicated by the pre-reading link.

11. The apparatus according to claim 10, further comprising:
a rule acquiring module, configured to acquire the pre-reading rules from a server.

12. The apparatus according to claim 11, wherein the rule acquiring module comprises:
a requesting unit, configured to request the pre-reading rules from the server, judge whether pre-reading rules stored in the server are the same as those stored in the client, and if different, update the pre-reading rules stored in the client by using the pre-reading rules stored in the server.

13. The apparatus according to claim 11, wherein the rule acquiring module is further configured to, after acquiring the pre-reading rules from the server, identify the type of the current web page, and acquire pre-reading rules corresponding to the type of the current web page from the pre-reading rules acquired by the server.

14. The apparatus according to claim 13, wherein the rule acquiring module comprises an identifying unit, configured to acquire the type of the current web page by querying according to a domain name or a link of the current web page and pre-stored website information category.

15. The apparatus according to claim 10, wherein the acquiring module comprises:
a judging unit, configured to judge whether the pre-reading rules comprise web address rules matching with the current web page, and if true, trigger an acquiring unit to acquire a link corresponding to the matched web address rules from the current web page and use the link as the pre-reading link.

16. The apparatus according to claim 15, wherein the judging unit is specifically configured to judge whether the pre-reading rules comprise a web address field of the current web page; wherein if true, the pre-reading rules comprise the web address rules matching with the current web page, and otherwise, the pre-reading rules do not comprise the web address rules matching with the current web page.

17. The apparatus according to claim 15, wherein the judging unit comprises:
a judging subunit, configured to judge whether the current web page comprises a keyword depicted in the matched web address rules, and if true, use the link corresponding to the keyword as the pre-reading link.

18. The apparatus according to claim 10, further comprising:
a reporting module, configured to record browsing details after the pre-reading rules are applied, compare the browsing details with the pre-reading rules, and report a success rate of the pre-reading rules to the server.

19. A mobile terminal, comprising a pre-reading apparatus according to claim 10.
